(19) United States
(12) Patent Application Publication
(10) Pub. No.: US 2026/0170720 A1
(43) Pub. Date: Jun. 18, 2026

(54) FACE SYNTHESIS METHOD AND SYSTEM

(71) Applicant: FLIPTION KOR, INC., Gyeonggi-do (KR)

(72) Inventors: Hoon Jin JUNG, Daejeon (KR); You Hyun JEONG, Daejeon (KR)

(21) Appl. No.: 18/710,901

(22) PCT Filed: Aug. 31, 2022
(86) PCT No.: PCT/KR2022/013038

§ 371 Date: May 16, 2024

(30) Foreign Application Priority Data
Nov. 19, 2021 (KR) 10-2021-0160569

(51) Int. Cl. G06T 11/60; G06V 10/44; G06V 40/16

(52) U.S. Cl. CPC G06T 11/60; G06V 10/44; G06V 40/171; G06V 40/172; G06T 2200/24

(57) ABSTRACT

Provided are a method and a system for synthesizing a face.

The face synthesis method may include: receiving a user's face image from a user; extracting user's face information including contour information, unique information, and fine information from the user's face image; comparing with the target face image, and selecting at least some of the user's face information as information to be used for face synthesis; training an artificial intelligence face synthesis model synthesizing the user's face image and the target face image using at least some of the selected user's face information; receiving an original image including the user's face; synthesizing a target face to the user's face for each frame of the original image using the artificial intelligence face synthesis model; and generating a result image from a frame in which synthesis is completed.

### TECHNICAL FIELD

The present invention relates to a method and a system for synthesizing a face.

### BACKGROUND ART

Face information processing technology is developing various fields including technology that detects faces in images, technology that extracts features from detected faces, and technology that performs authentication through face recognition, and furthermore, technology that replaces a person's face with another face or synthesizes faces. In particular, the practical use of the face information processing technology is accelerating thanks to the widespread spread of artificial intelligence technology and the development of hardware that can process and transmit large amounts of data.

In particular, various types of face synthesis technologies have been commercialized, such as synthesizing various contents to the face, replacing a part or the entire face with another face while leaving the body, or synthesizing a part or the entire existing face with another face, and services using the face synthesis technology are mainly required for real-time or fast response time. Accordingly, research is being actively conducted to implement the face synthesis technology in an efficient scheme.

### DISCLOSURE

### Technical Problem

The present disclosure attempts to provide a method and a system for synthesizing a face, which are capable of synthesizing a target face desired by a user with an image in which the user appears in an efficient scheme.

### Technical Solution

An example embodiment of the present invention provides a face synthesis method which may include: receiving a user's face image from a user; extracting user's face information including contour information, unique information, and fine information from the user's face image; comparing with the target face image, and selecting at least some of the user's face information as information to be used for face synthesis; training an artificial intelligence face synthesis model synthesizing the user's face image and the target face image using at least some of the selected user's face information; receiving an original image including the user's face; synthesizing a target face to the user's face for each frame of the original image using the artificial intelligence face synthesis model; and generating a result image from a frame in which synthesis is completed.

In some example embodiments of the present invention, the synthesizing of the target face may include recognizing the user's face in one frame, inputting the target face image and the user's face recognized in the one frame into the artificial intelligence face synthesis model, obtaining a synthesis face image from the artificial intelligence face synthesis model, and inserting the synthesis face image into the one frame.

In some example embodiments of the present invention, the inputting of the target face image and the user's face recognized in the one frame into the artificial intelligence face synthesis model may include inputting at least some of the user's face information selected into the artificial intelligence face synthesis model.

In some example embodiments of the present invention, the method may further include: providing a plurality of candidate face images to a user terminal; and determining a candidate face image selected by the user terminal among the plurality of candidate face images as the target face image.

In some example embodiments of the present invention, the method may further include providing the user terminal with an editing interface for a face image.

In some example embodiments of the present invention, the method may further include: analyzing and distinguishing a display section in which the user's face is displayed and a non-display section in which the user's face is not displayed in the original image, and the synthesizing may include synthesizing the target face only with respect to a frame included in the display section.

In some example embodiments of the present invention, the generating of the result image may include generating the result image by connecting the non-display section, and the display section in which synthesis of the target face is completed

In some example embodiments of the present invention, the method may further include encoding the result image and transmitting the result image to the user terminal.

Another example embodiment of the present invention provides a face synthesis system which may include: a user's face image reception module receiving a user's face image from a user; a user's face information extraction module extracting user's face information including contour information, unique information, and fine information from the user's face image; a synthesis information selection module comparing with the target face image, and selecting at least some of the user's face information as information to be used for face synthesis; a training module training an artificial intelligence face synthesis model synthesizing the user's face image and the target face image using at least some of the selected user's face information; an original image reception module receiving an original image including the user's face; a face synthesis module synthesizing a target face to the user's face for each frame of the original image using the artificial intelligence face synthesis model; and a result image generation module generating a result image from a frame in which synthesis is completed.

In some example embodiments of the present invention, the face synthesis module may include a frame-specific synthesis module recognizing the user's face in one frame, inputting the target face image and the user's face recognized in the one frame into the artificial intelligence face synthesis model, and obtaining a synthesis face image from the artificial intelligence face synthesis model, and a frame-specific correction module inserting the synthesis face image into the one frame.

In some example embodiments of the present invention, the face synthesis module may additionally input at least some of the user's face information selected into the artificial intelligence face synthesis model.

In some example embodiments of the present invention, the face synthesis system may further include a target face determination module providing a plurality of candidate face images to a user terminal; and determining a candidate face image selected by the user terminal among the plurality of candidate face images as the target face image.

In some example embodiments of the present invention, the target face determination module may provide the user terminal with an editing interface for a face image.

In some example embodiments of the present invention, the face synthesis module may further include a section analysis module analyzing and distinguishing a display section in which the user's face is displayed and a non-display section in which the user's face is not displayed in the original image, and the face synthesis module may synthesize the target face only with respect to a frame included in the display section.

In some example embodiments of the present invention, the result image generation module may generate the result image by connecting the non-display section, and the display section in which synthesis of the target face is completed.

In some example embodiments of the present invention, the system may further include a result image transmission module encoding the result image and transmitting the result image to the user terminal.

Yet another example embodiment of the present invention provides a computer-readable medium having a program for executing the steps, which is recorded in a computer, in which the steps may include: receiving a user's face image from a user; extracting user's face information including contour information, unique information, and fine information from the user's face image; comparing with the target face image, and selecting at least some of the user's face information as information to be used for face synthesis; training an artificial intelligence face synthesis model synthesizing the user's face image and the target face image using at least some of the selected user's face information; receiving an original image including the user's face; synthesizing a target face to the user's face for each frame of the original image using the artificial intelligence face synthesis model; and generating a result image from a frame in which synthesis is completed.

### Advantageous Effects

According to example embodiments of the present disclosure, there is an advantage in that face synthesis can be performed even with respect to other face shapes having various arbitrary angles or expressions using only one target image selected by a user and one artificial intelligence face synthesis model. Accordingly, not only the use of computer resources is reduced and processing time is shortened, thereby increasing user satisfaction, but the already learned artificial intelligence face synthesis model can be reused, making it highly efficient and economical.

### DESCRIPTION OF THE DRAWINGS

FIG. 1 is a diagram for describing a face synthesis system according to an example embodiment of the present invention.

FIG. 2 is a diagram for describing an operation of a face synthesis system according to an example embodiment of the present invention.

FIG. 3 is a diagram for describing a face synthesis method according to an example embodiment of the present invention.

FIGS. 4 and 5 are diagrams for describing an operation of a face synthesis system according to another example embodiment of the present invention.

FIG. 6 is a diagram for describing an operation of a face synthesis system according to yet another example embodiment of the present invention.

FIG. 7 is a block diagram for describing a computing device for implementing a method and a system for synthesizing a face according to example embodiments of the present invention.

### MODE FOR INVENTION

Hereinafter, example embodiments of the present invention will be described in detail with reference to the accompanying drawings. In the drawings, parts not associated with description are omitted for clearly describing the present invention and like reference numerals designate like elements throughout the specification.

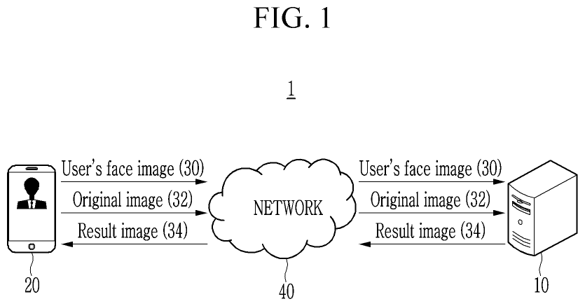

FIG. 1 is a diagram for describing a face synthesis system according to an example embodiment of the present invention.

Referring to FIG. 1, the face synthesis system 1 according to an example embodiment of the present invention may include a face synthesis server 10 and a user terminal 20.

The face synthesis server 10 may synthesize a target face desired by a user into an image in which the user appears. Specifically, the face synthesis server 10 may receive a user's face image 30 and an original image 32 from the user terminal 20. Here, the user's face image 30 may be a face image (for example, the user's own face image) recorded in the original image 32 before face synthesis. Meanwhile, the original image 32 may be an image in which a user's face corresponding to the user's face image 30 appears, and is mainly in the form of a video, but the scope of the present invention is not limited to the video.

The face synthesis server 10 may perform face synthesis using the user's face image 30 and the original image 32, then output a result image 34 and transmit the result image 34 to the user terminal 20. The result image 34 refers an image in which the user's face corresponding to the user's face image 30 in the original image 32 is synchronized with the target face desired by the user.

In FIG. 1, the face synthesis system 1 is expressed as a structure the user terminal 20 provides the user's face image 30 and the original image 32 to the face synthesis server 10, and the face synthesis server 10 provides the result image 34 to the user terminal 20, but the scope of the present invention is not limited to such server-client architecture. Unlike illustrated in FIG. 1, some or all of the functions implemented in the face synthesis server 10 described in this specification may be implemented within the user terminal 20. For example, the process of performing the face synthesis using the user's face image 30 and the original image 32, and then generating the result image 34 may be fully performed within the user terminal 20 without performing a task in a separate server. Nevertheless, for convenience of description, the following description will be made assuming the architecture illustrated in FIG. 1 in which the face synthesis server 10 and the user terminal 20 exchange data through a network 40.

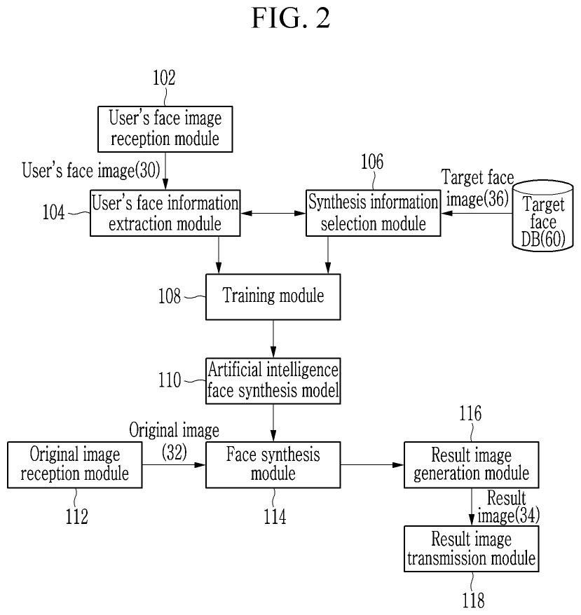

FIG. 2 is a diagram for describing an operation of a face synthesis system according to an example embodiment of the present invention.

Referring to FIG. 2, the face synthesis system according to an example embodiment of the present invention may include a user's face image reception module 102, a user's face information extraction module 104, a synthesis information selection module 106, a training module 108, an artificial intelligence face synthesis model 110, an original image reception module 112, a face synthesis module 114, a result image generation module 116, and a result image transmission module 118. As described above, at least some of the modules may be implemented in the face synthesis server 10 which communicates with the user terminal 20, and all of the modules may be implemented in the user terminal 20, and as necessary, some of the modules may be implemented in the face synthesis server 10 and some others may be implemented in the user terminal 20.

The user's face image reception module 102 may receive the user's face image 30 from the user. The user's face image 30 may be an image captured using a camera mounted on the user terminal 20, or may be an image provided from another external device. The user's face image 30 is an image to be synthesized with a target face image, which will be described later, and may be an image captured from the front so that the user's eyebrows, eyes, nose, mouth, etc. are all visible.

The user's face information extraction module 104 may extract user's face information from the user's face image 30 received from the user's face image reception module 102, and the user's face information may include contour information, unique information, and fine information.

The contour information may be a contour of the face, that is, the shape of the face excluding characteristic elements such as eyebrows, eyes, nose, and mouth in the face. The contour information may be used to designate a region where face synthesis is not performed, and the face synthesis method according to example embodiments of the present invention performs synthesis only for an internal region of the face except for the contour of the face based on the contour information extracted by the user's face information extraction module 104. As a result, not only user satisfaction may be increased as synthesis s performed so that the original appearance of the face is maintained, but also crimes such as deepfake, which uses artificial intelligence technology to synthesize a face of a specific person into another image, and ethical problems may be prevented.

Unique information as characteristic information that may distinguish a face, may be facial features and their arrangement. Specifically, the unique information includes information about characteristic elements within a face that are relatively easy to compare with other faces, including the ears, eyes, mouth, nose, etc., of the face. The unique information may include not only the shape of the above characteristic elements themselves, but also information indicating where the elements are located on the face. For example, assuming a virtual rectangular box surrounding the contour of the face, the information may be a numerical representation of the positions of the ears, eyes, mouth, nose, etc. from the center of the rectangular box.

The fine information is information preserved for the naturalness of facial synthesis and may include expressions, light and dark, wrinkles, etc. Specifically, the fine information may represent information about expressions, light and dark, wrinkles, etc. as values that a computer may recognize. be expressed as different values, or the degree of light and dark may be represented as a value for each stage, or the degree of wrinkles may be expressed in stages, or the type of wrinkle may be represented as a value or the location where wrinkles are distributed on the face may be represented as a value.

Such unique information and fine information are information directly used in face synthesis, unlike the contour information described above.

The synthesis information selection module 106 may compare the user's face image 30 with the target face image 36 and select at least some of the user's face information as information to be used for face synthesis. Here, the target face image 36 is a face image that the user selects to synthesize with his or her own face, and may be stored, for example, in the target face database 60. That is, the synthesis information selection module 106 may compare the target face image 36 selected by the user among the target face images stored in the target face database 60 with the user's face image 30.

Specifically, the comparison may be achieved by extracting features from the image using a Convolutional Neural Networks (CNN)-based encoder model, projecting the target face information onto the user's face information in a deep layer of the model, and then generating a new image through a decoder with respect to the synthesized information, extracting information from a result image, and comparing the extracted information with the contour and fine information of the user's face, and the unique information of the target face again.

As described above, a weight may be set for the result selected as the information to be used in face synthesis, and natural synthesis quality may be implemented by adjusting the set weight.

The training module 108 may train an artificial intelligence face synthesis model 110 that synthesizes the user's face image 30 and the target face image 36 using at least some of the user's face information selected by the synthesis information selection module 106.

The artificial intelligence face synthesis model 110 may recognize the user's face corresponding to the user's face image 30 in a given image, and output a result of synthesizing the target face corresponding to the target face image 36 with the recognized user's face. The artificial intelligence face synthesis model 110 may be a convolutional neural networks (CNN) based model, but the scope of the present invention is not limited thereto.

The original image reception module 112 may receive the original image 32 including the user's face. Here, the original image 32 may be a video, but the scope of the present invention is not limited thereto, and may be a single still image or an image expressing a short video with only a few frames, such as a dynamic GIF.

The face synthesis module 114 may synthesize the target face with the user's face for each frame of the original image using the artificial intelligence face synthesis model 110.

Specifically, the face synthesis module 114 may repeatedly perform the process of recognizing the region corresponding to the user's face in the original image 32 including the user's face provided by the original image reception module 112. When the region corresponding to the user's face is recognized, the target face may be synthesized with the user's face using the artificial intelligence face synthesis model 110 based on at least some of the user's face information selected by the synthesis information selection module 106, and to this end, the synthesis information selection module 106 may input the user's face recognized from the original image 32 and the target face image 36 to the artificial intelligence face synthesis model 110.

Alternatively, the synthetic information selection module 106 may additionally input at least some of the user's face information selected by the synthetic information selection module 106 in addition to the user's face recognized on the original image 32 and the target face image 36 into the artificial intelligence face synthesis model 110.

The result image generation module 116 may generate the result image from the frame for which synthesis is completed.

The result image transmission module 118 may encode the result image generated by the result image generation module 116 and transmit the result image to the user terminal 20.

In related art, a lot of data are required to perform face synthesis and the processing time is long, and an artificial intelligence model used for face synthesis is only capable of synthesizing specific angles or expressions, so in order to synthesize faces with various angles or expressions, multiple artificial intelligence models are needed. As a result, not only the consumption of computing resources is large, but the processing time is also long, causing user dissatisfaction, and further, a new artificial intelligence model should be applied each time to various face shapes, resulting in low memory efficiency and high costs.

However, according to the example embodiment, there is an advantage in that face synthesis can be performed even with respect to other face shapes having various arbitrary angles or expressions using only one target image selected by a user and one artificial intelligence face synthesis model 110. Accordingly, not only the use of computer resources is reduced and processing time is shortened, thereby increasing user satisfaction, but the already learned artificial intelligence face synthesis model 110 can be reused, making it highly efficient and economical.

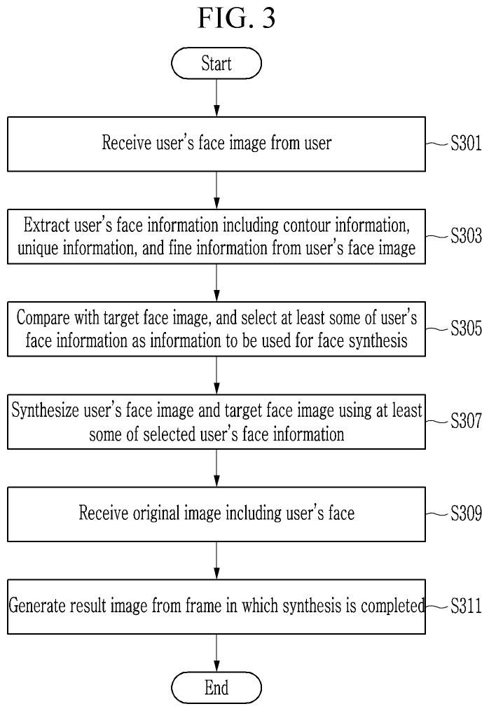

FIG. 3 is a diagram for describing a face synthesis method according to an example embodiment of the present invention.

Referring to FIG. 3, the face synthesis method according to an example embodiment of the present invention may include: receiving a user's face image 30 from a user (S301); extracting user's face information including contour information, unique information, and fine information from the user's face image 30 (S303); comparing with the target face image 36, and selecting at least some of the user's face information as information to be used for face synthesis (S305); synthesizing the user's face image 30 and the target face image 36 using at least some of the selected user's face information (S307); receiving an original image including the user's face (S309); synthesizing a target face to the user's face for each frame of the original image using the artificial intelligence face synthesis model 110 (S311); and generating a result image from a frame in which synthesis is completed (S313).

For details related thereto, the content described in relation to FIGS. 1 and 2 may be applied, so redundant description will be omitted here. Meanwhile, the face synthesis method according to an example embodiment of the present invention may include steps for performing the operation of the face synthesis system described in this specification.

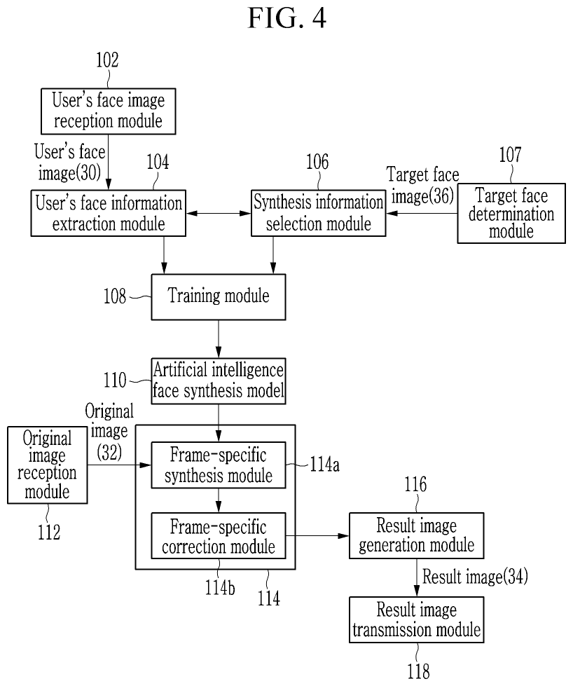

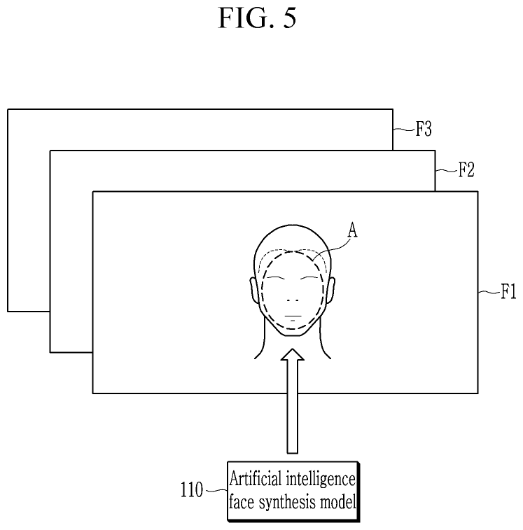

FIGS. 4 and 5 are diagrams for describing an operation of a face synthesis system according to another example embodiment of the present invention.

Referring to FIG. 4, the face synthesis system according to another example embodiment of the present invention may further include a target face determination module 107. The target face determination module 107 may provide a plurality of candidate face images to the user terminal. Here, the plurality of candidate face images are images for suggesting or recommending to the user so that the user may select the target face image. For example, the target face determination module 107 may provide photos of celebrities A, B, and C as candidate face images to the user and then wait for the user's selection, and when the user selects celebrity B through the user terminal 20 among the plurality of candidate face images, the target face determination module 107 may determine the candidate face image of the selected celebrity B as the target face image 36.

In some example embodiments of the present invention, the target face determination module 107 may provide the user terminal 20 with an editing interface for a face image. The user may edit the candidate face image selected thereby in detail through the editing interface provided through the user terminal 20. For example, the user may edit eyes, nose, age, etc. of the candidate face image selected thereby. Accordingly, face synthesis may be performed according to a direction in which the user wants his or her face to change.

In addition, the user may be provided, as a sample, a result of synthesizing the target face with the user's face through the artificial intelligence face synthesis model 110 through the editing interface provided through the user terminal 20, and edit a face image corresponding to the sample in detail. For example, the user may edit the eyes, nose, age, etc. of the face image corresponding to the synthetic sample result, and the user's corrections received through the editing interface are allowed to be reflected on the result of the artificial intelligence face synthesis model 110, and even when the face synthesis module 114 performs a task of synthesizing a face in an image, face synthesis may be performed according to a direction in which the user wants his or her face to change.

Further, referring to FIGS. 4 and 5, the face synthesis module 114 of the face synthesis system according to another example embodiment of the present invention may include a frame-specific synthesis module 114a and a frame-specific correction module 114b.

The frame-specific synthesis module 114a may recognize the user's face in one frame, input the target face image 36 and the user's face recognized in one frame to the artificial intelligence face synthesis model 110, and obtain a synthesis face image from the artificial intelligence face synthesis model 110, and the frame-specific correction module 114b may insert the synthesis face image into one frame.

As illustrated in FIG. 5, when the original image 32 received by the original image module 112 is a video or a short video, the original image 32 may be constituted by a plurality of frames F1, F2, and F3. The frame-specific synthesis module 114a may recognize the user's face in each of the plurality of frames F1, F2, and F3, and for example, may recognize the user's face with a region A in one frame F1. Then, the frame-specific synthesis module 114a may input the user's face recognized as the region A into the artificial intelligence face synthesis model 110.

Here, a boundary of the region A may vary depending on a specific implementation method. For example, the frame-specific synthesis module 114a may recognize only a region that does not include the contour of the face as the user's face, as illustrated in FIG. 5, or, differently, even the region that includes the contour of the face as the user's face. In any case, as described above with respect to the contour information in relation to FIG. 2, in face synthesis, face synthesis may not be performed on the contour of the face.

Meanwhile, as described above, the artificial intelligence face synthesis model 110 is an artificial intelligence model trained using the user's face image 30 and the target face image 36 as an input, and may output a synthesis result of the user's face image 30 and the target face image 36. Accordingly, the frame-specific synthesis module 114a inputs the user's face recognized in the region A of one frame F1 into the artificial intelligence face synthesis model 110 to obtain a synthesis result of the target face image 36 to be expressed in the corresponding region A. The frame-specific correction module 114b may insert the synthesis face image obtained by the frame-specific synthesis module 114a into the corresponding frame F1, and the operations of the frame-specific synthesis module 114a and the frame-specific correction module 114b may be repeatedly performed with respect to the plurality of frames F1, F2, and F3 of the original image 32.

The result of completing face synthesis for the plurality of frames F1, F2, and F3 may be delivered to the result image generation module 116, and the result image generation module 116 may process the frames for which synthesis is completed and generate the result image 34 in a form to be played back in the user terminal 20.

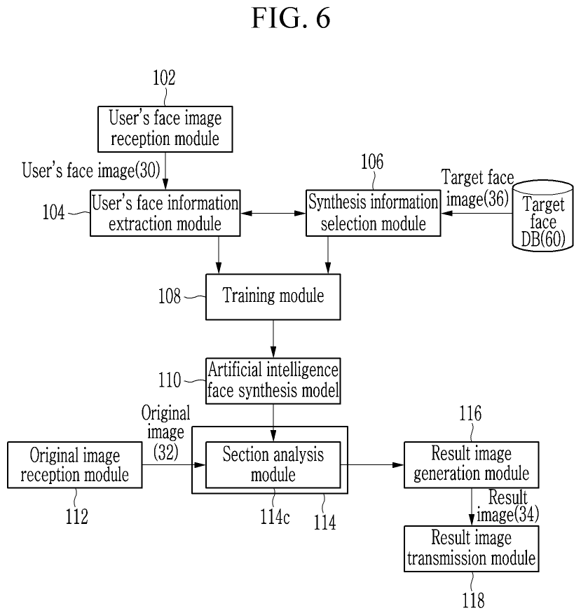

FIG. 6 is a diagram for describing an operation of a face synthesis system according to yet another example embodiment of the present invention.

Referring to FIG. 6, the face synthesis module 114 of the face synthesis system according to another example embodiment of the present invention may include a section analysis module 114c.

The section analysis module 114c may analyze and distinguish a display section in which the user's face is displayed and a non-display section in which the user's face is not displayed in the original image 32. In general, the user's face does not always appear in the image, so rather than attempting to detect a face region in all frames of the image, it is more efficient to select the display section where the user's face is displayed before starting a frame-specific task. After the section analysis module 114c distinguishes the display section in which the user's face is displayed in the original image 32, the face synthesis module 114 may synthesize the target face only for the frame included in the display section.

For example, when the section analysis module 114c analyzes the display section and the non-display section, the section analysis module 114c may check only whether a person face is displayed in a thumbnail of the original image 32, and when the display section is determined in such a scheme, a scheme of precisely detecting whether there is the user's face may be used with respect to the display section.

Accordingly, the face synthesis module 114 may perform face synthesis on an image set as the display section by the section analysis module 114c, and then deliver the result to the result image generation module 116, and deliver an image set as the non-display section to the result image generation module 116 without any special processing. Then, the result image generation module 116 may generate the result image 34 by connecting the non-display section and the display section in which the synthesis of the target face is completed.

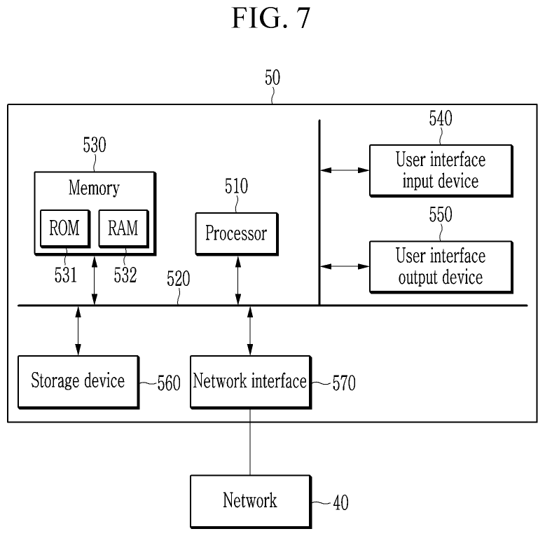

FIG. 7 is a block diagram for describing a computing device for implementing a method and a system for synthesizing a face according to example embodiments of the present invention.

Referring to FIG. 7, the method and system for synthesizing a face according to the example embodiments of the present invention may be implemented by using a computing device 50.

The computing device 50 may include at least one of a processor 510, a memory 530, a user interface input device 540, a user interface output device 550, and a storage device 560 which communicate with each other through a bus 520. The computing device 50 may also include a network interface 570 electrically connected to a network 40, e.g., a wireless network. The network interface 570 may transmit or receive a signal to or from another entity through the network 40.

The processor 510 may be implemented as various types including an application processor (AP), a central processing unit (CPU), a graphic processing unit (GPU), etc., and may be an arbitrary semiconductor device that executes an instruction stored in the memory 530 or the storage device 560. The processor 510 may be configured to implement the functions and methods described in FIGS. 1 to 6.

The memory 530 and the storage device 560 may include be various types of volatile or non-volatile storage media. For example, the memory may include a read only memory (ROM) 531 and a random access memory (RAM) 532. In an example embodiment of the present invention, the memory 530 may be positioned inside or outside the processor 510 and connected with the processor 510 by various well-known means.

Further, the method and the system for synthesizing a face according to the example embodiments of the present invention may be implemented as a program or software executed by the computing device 50 or the program or software may be stored in a computer readable medium.

Further, the method and the system for synthesizing a face according to the example embodiments of the present invention may be implemented as hardware which may be electrically connected to the computing device 50.

According to the example embodiments of the present invention described up to now, there is an advantage in that face synthesis can be performed even with respect to other face shapes having various arbitrary angles or expressions using only one target image selected by a user and one artificial intelligence face synthesis model. Accordingly, not only the use of computer resources is reduced and processing time is shortened, thereby increasing user satisfaction, but the already learned artificial intelligence face synthesis model can be reused, making it highly efficient and economical.

While the example embodiments of the present invention have been described in connection with what is presently considered to be practical example embodiments, it is to be understood that the invention is not limited to the disclosed embodiments, but, on the contrary, is intended to cover various modifications and equivalent arrangements included within the spirit and scope of the appended claims.

1. A face synthesis method comprising:
receiving a user's face image from a user;
extracting user's face information including contour information, unique information, and fine information from the user's face image;
comparing with the target face image, and selecting at least some of the user's face information as information to be used for face synthesis;
training an artificial intelligence face synthesis model synthesizing the user's face image and the target face image using at least some of the selected user's face information;
receiving an original image including the user's face;
synthesizing a target face to the user's face for each frame of the original image using the artificial intelligence face synthesis model; and
generating a result image from a frame in which synthesis is completed.

2. The face synthesis method of claim 1, wherein:
the synthesizing of the target face includes
recognizing the user's face in one frame,
inputting the target face image and the user's face recognized in the one frame into the artificial intelligence face synthesis model,
obtaining a synthesis face image from the artificial intelligence face synthesis model, and
inserting the synthesis face image into the one frame.

3. The face synthesis method of claim 2, wherein:
the inputting of the target face image and the user's face recognized in
the one frame into the artificial intelligence face synthesis model includes inputting at least some of the user's face information selected into the artificial intelligence face synthesis model.

4. The face synthesis method of claim 1, further comprising:
providing a plurality of candidate face images to a user terminal; and
determining a candidate face image selected by the user terminal among the plurality of candidate face images as the target face image.

5. The face synthesis method of claim 4, further comprising:
providing the user terminal with an editing interface for a face image.

6. The face synthesis method of claim 1, further comprising:
analyzing and distinguishing a display section in which the user's face is displayed and a non-display section in which the user's face is not displayed in the original image,
wherein the synthesizing includes synthesizing the target face only with respect to a frame included in the display section.

7. The face synthesis method of claim 6, wherein:
the generating of the result image includes generating the result image by connecting the non-display section, and the display section in which synthesis of the target face is completed.

8. The face synthesis method of claim 1, further comprising:
encoding the result image and transmitting the result image to the user terminal.

9. A face synthesis system comprising:
a user's face image reception module receiving a user's face image from a user;
a user's face information extraction module extracting user's face information including contour information, unique information, and fine information from the user's face image;
a synthesis information selection module comparing with the target face image, and selecting at least some of the user's face information as information to be used for face synthesis;
a training module training an artificial intelligence face synthesis model synthesizing the user's face image and the target face image using at least some of the selected user's face information;
an original image reception module receiving an original image including the user's face;
a face synthesis module synthesizing a target face to the user's face for each frame of the original image using the artificial intelligence face synthesis model; and
a result image generation module generating a result image from a frame in which synthesis is completed.

10. The face synthesis system of claim 9, wherein:
the face synthesis module includes,
a frame-specific synthesis module recognizing the user's face in one frame, inputting the target face image and the user's face recognized in the one frame into the artificial intelligence face synthesis model, and obtaining a synthesis face image from the artificial intelligence face synthesis model, and
a frame-specific correction module inserting the synthesis face image into the one frame.

11. The face synthesis system of claim 10, wherein:
the face synthesis module additionally inputs at least some of the user's face information selected into the artificial intelligence face synthesis model.

12. The face synthesis system of claim 9, further comprising:
a target face determination module providing a plurality of candidate face images to a user terminal; and determining a candidate face image selected by the user terminal among the plurality of candidate face images as the target face image.

13. The face synthesis system of claim 12, wherein:
the target face determination module provides the user terminal with an editing interface for a face image.

14. The face synthesis system of claim 9, wherein:
the face synthesis module further includes a section analysis module analyzing and distinguishing a display section in which the user's face is displayed and a non-display section in which the user's face is not displayed in the original image, and
the face synthesis module synthesizes the target face only with respect to a frame included in the display section.

15. The face synthesis system of claim 14, wherein:
the result image generation module generates the result image by connecting the non-display section, and the display section in which synthesis of the target face is completed.

16. The face synthesis system of claim 9, further comprising:
a result image transmission module encoding the result image and transmitting the result image to the user terminal.

17. A computer-readable medium having a program for executing the steps, which is recorded in a computer, the steps comprising:
receiving a user's face image from a user;
extracting user's face information including contour information, unique information, and fine information from the user's face image;
comparing with the target face image, and selecting at least some of the user's face information as information to be used for face synthesis;
training an artificial intelligence face synthesis model synthesizing the user's face image and the target face image using at least some of the selected user's face information;
receiving an original image including the user's face;
synthesizing a target face to the user's face for each frame of the original image using the artificial intelligence face synthesis model; and
generating a result image from a frame in which synthesis is completed.
